(19) United States
(12) Patent Application Publication
(10) Pub. No.: US 2023/0127766 A1
(43) Pub. Date: Apr. 27, 2023

(54) POLYURETHANE HOT MELT ADHESIVE

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHEN-WEI CHANG, TAIPEI (TW)

(21) Appl. No.: 17/873,337

(22) Filed: Jul. 26, 2022

(30) Foreign Application Priority Data
Oct. 25, 2021 (TW) 110139408

(51) Int. Cl. C09J 175/04

(52) U.S. Cl. CPC C09J 175/04; C08G 2170/20; C09J 2301/304

(57) ABSTRACT

A polyurethane hot melt adhesive is provided. The polyurethane hot melt adhesive is formed by reacting an isocyanate component, a polyol component, and a chain extender component. The polyol component includes a first polyol and a second polyol, a number-average molecular weight of the first polyol is within a range from 650 to 1,500, and a number-average molecular weight of the second polyol is within a range from 1,500 to 3,000. The chain extender component includes a first chain extender and a second chain extender, and the second chain extender is a diyol having an ether group or a hydrocarbyl. A ratio between a weight percentage of the first chain extender and a weight percentage of the second chain extender is within a range from 9:1 to 4:1. A forming temperature of the polyurethane hot melt adhesive is within a range from 100° C. to 150° C.

### CROSS-REFERENCE TO RELATED PATENT APPLICATION

This application claims the benefit of priority to Taiwan Patent Application No. 110139408, filed on Oct. 25, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane hot melt adhesive, and more particularly to a polyurethane hot melt adhesive having a low forming temperature and a low crystallinity.

### BACKGROUND OF THE DISCLOSURE

Generally, a conventional polyurethane hot melt adhesive applicable to a shoe material has a high crystallinity, so that the conventional polyurethane hot melt adhesive has a high adhesive property and can be applied to the shoe material. However, the conventional polyurethane hot melt adhesive with the high crystallinity has a relatively high forming temperature (e.g., greater than 150° C.). Thus, when the conventional polyurethane hot melt adhesive is applied to the shoe material, the forming temperature may be too high, thereby causing deformation of the shoe material or a texture of the shoe material to fade.

Therefore, how to provide a polyurethane hot melt adhesive having a low forming temperature, so as to overcome the above-mentioned deficiency, has become one of the important issues to be solved in the field.

### SUMMARY OF THE DISCLOSURE

In response to the above-referenced technical inadequacy, the present disclosure provides a polyurethane hot melt adhesive having a relatively low forming temperature.

In one aspect, the present disclosure provides a polyurethane hot melt adhesive. The polyurethane hot melt adhesive is formed by reacting an isocyanate component, a polyol component, and a chain extender component. The polyol component includes a first polyol and a second polyol, a number-average molecular weight of the first polyol is within a range from 650 to 1,500, and a number-average molecular weight of the second polyol is within a range from 1,500 to 3,000. The chain extender component includes a first chain extender and a second chain extender. The first chain extender is at least one selected from the group consisting of 1,4-butanediol and ethylene glycol. The second chain extender is a diyol having an ether group or a hydrocarbyl, and the second chain extender has a carbon number that is less than or equal to 8. A ratio between a weight percentage of the first chain extender and a weight percentage of the second chain extender is within a range from 9:1 to 4:1. The polyurethane hot melt adhesive has a hard segment and a soft segment, the hard segment is formed by the isocyanate component and the chain extender component, and the soft segment is formed by the polyol component. A hard segment ratio is defined by a weight percentage of the hard segment divided by a sum of the weight percentage of the hard segment and a weight percentage of the soft segment, and the hard segment ratio of the polyurethane hot melt adhesive is within a range from 25% to 45%. An analysis result of the polyurethane hot melt adhesive by the differential scanning calorimetry includes two peaks, the two peaks respectively correspond to a first melting point and a second melting point, the first melting point is within a range from 90° C. to 111.69° C., and the second melting point is within a range from 111.69° C. to 150° C. An area encompassing the first melting point is 20% to 40% of a total area, the total area is defined as an area that is surrounded by a DSC curve and a baseline in the analysis result, and the baseline is defined as a straight line connecting a lower limit of the first melting point and an upper limit of the second melting point. A forming temperature of the polyurethane hot melt adhesive is within a range from 100° C. to 150° C.

In certain embodiments, the second chain extender is at least one selected from the group consisting of diethylene glycol, dipropylene glycol, and neopentyl glycol.

In certain embodiments, based on 100 parts by weight of the polyurethane hot melt adhesive, a content of the isocyanate component is 27 to 30 parts by weight, a content of the polyol component is 66 to 70 parts by weight, and a content of the chain extender component is 3 to 4 parts by weight.

In certain embodiments, under a temperature condition of 110° C. to 120° C., a rheological viscosity of the polyurethane hot melt adhesive is within a range from 2,000 Pa·s to 5,000 Pa·s.

In certain embodiments, a ratio between a weight percentage of the first polyol and a weight percentage of the second polyol is within a range from 9:1 to 1.5:1.

In certain embodiments, the first polyol is at least one selected from the group consisting of adipic acid-butanediol, adipic acid-butanediol-ethylene glycol, and adipic acid-succinic acid-hexanediol, and the second polyol is at least one selected from the group consisting of adipic acid-butanediol, adipic acid-butanediol-ethylene glycol, and adipic acid-succinic acid-hexanediol.

In certain embodiments, the forming temperature of the polyurethane hot melt adhesive is within a range from 110° C. to 130° C.

In certain embodiments, an analysis result of the polyurethane hot melt adhesive by a gel permeation chromatography (GPC) only includes one peak.

In certain embodiments, the polyurethane hot melt adhesive further includes a high heat resistant antioxidant, a UV absorbent, and a hydrolysis inhibitor. Based on 100 parts by weight of the polyurethane hot melt adhesive, a content of the high heat resistant antioxidant is 0.1 to 1 parts by weight, a content of the UV absorbent is 0.1 to 0.8 parts by weight, and a content of the hydrolysis inhibitor is 0.2 to 2 parts by weight.

In certain embodiments, the high heat resistant antioxidant is at least one selected from the group consisting of tetrakis(β-(3,5-di-tert-butyl-4-hydroxyphenyl)propanoate)pentaerythritol, 3-(3,5-di-tert-butyl-4-hydroxybenzyl)mesitylene, and β-(4-hydroxyphenyl-3,5-di-tert-butyl)propionic acid n-octadecyl ester. The UV absorbent is at least one selected from the group consisting of bis(2,2,6,6-tetramethyl-4-pyridyl)sebacate, 2-(2H-benzotriazol-2-yl)-4,6-bis(1-methyl-1-phenylethyl)phenol, and 2-(2H-benzotriazol-2-yl)-6-dodecyl-4-methylphenol. The hydrolysis inhibitor is at least one selected from the group consisting of bis(2,6-diisopropylphenyl)carbodiimide and bis(4-phenoxy-2,6-diisopropylphenyl)carbodiimide.

Therefore, in the polyurethane hot melt adhesive provided by the present disclosure, by virtue of “the second chain extender is a diyol having an ether group or a hydrocarbyl,” “a ratio between a weight percentage of the first chain extender and a weight percentage of the second chain extender is within a range from 9:1 to 4:1,” and “the hard segment ratio of the polyurethane hot melt adhesive is within a range from 25% to 45%,” the polyurethane hot melt adhesive can have a relatively low forming temperature.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an analysis result of a polyurethane hot melt adhesive by a gel permeation chromatography (GPC) according to an embodiment of the present disclosure; and

FIG. 2 is a schematic diagram of an analysis result of the polyurethane hot melt adhesive by a differential scanning calorimetry (DSC) according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An embodiment of present disclosure provides a polyurethane hot melt adhesive. The polyurethane hot melt adhesive is applicable to shoe substrate materials, and the polyurethane hot melt adhesive has a relatively low forming temperature, a relatively low crystallinity, and an excellent adhesive property. More specifically, the forming temperature of the polyurethane hot melt adhesive is within a range from 100° C. to 150° C., and the crystallinity of the polyurethane hot melt adhesive is within a range from 20% to 50%. Preferably, the forming temperature of the polyurethane hot melt adhesive is within a range from 110° C. to 130° C., and the crystallinity of the polyurethane hot melt adhesive is within a range from 25% to 45%.

The polyurethane hot melt adhesive is formed by reacting an isocyanate component, a polyol component, and a chain extender component. Based on 100 parts by weight of polyurethane hot melt adhesive, a content of the isocyanate component is 27 to 30 parts by weight, a content of the polyol component is 66 to 70 parts by weight, and a content of the chain extender component is 3 to 4 parts by weight. In the present embodiment, the isocyanate component is at least one selected from the group consisting of methylene diphenyl diisocyanate (MDI), 4,4′-methylene dicyclohexyl diisocyanate (H12MDI), and isophorone diisocyanate (IPDI), but the present disclosure is not limited thereto.

The polyol component includes a first polyol and a second polyol, a number-average molecular weight of the first polyol is within a range from 650 to 1,500, and a number-average molecular weight of the second polyol is within a range from 1,500 to 3,000. In other words, the number-average molecular weight of the second polyol is 100% to 450% of the number-average molecular weight of the first polyol. Preferably, the number-average molecular weight of the first polyol is within a range from 900 to 1,200, and the number-average molecular weight of the second polyol is within a range from 1,800 to 2,700.

In the polyol component of the present embodiment, a weight percentage of the first polyol is greater than a weight percentage of the second polyol, and a ratio between the weight percentage of the first polyol and the weight percentage of the second polyol is within a range from 9:1 to 1.5:1, but the present disclosure is not limited thereto. Preferably, the ratio between the weight percentage of the first polyol and the weight percentage of the second polyol is within a range from 7:1 to 3.5:1. In other words, in the polyol component of the present embodiment, a content of the first polyol is 60 to 90 parts by weight, and a content of the second polyol is 10 to 40 parts by weight.

In the present embodiment, the first polyol is at least one selected from the group consisting of adipic acid-butanediol, adipic acid-butanediol-ethylene glycol, and adipic acid-succinic acid-hexanediol, and the second polyol is at least one selected from the group consisting of adipic acid-butanediol, adipic acid-butanediol-ethylene glycol, and adipic acid-succinic acid-hexanediol, but the present disclosure is not limited thereto. In other words, the first polyol and the second polyol can be selected from the same group, but the number-average molecular weight and a degree of aggregation of the first polyol are different from those of the second polyol.

The chain extender component includes a first chain extender and a second chain extender. The first chain extender is selected from the group consisting of 1,4-butanediol and ethylene glycol, and the second chain extender is a diyol having an ether group (—O—) or a hydrocarbyl. In the present embodiment, the second chain extender is at least one selected from the group consisting of diethylene glycol, dipropylene glycol, and neopentyl glycol.

In other words, the first chain extender is a diyol having a symmetrical structure and having a carbon number that is less than or equal to 8, and the second chain extender is a diyol having an ether group or a hydrocarbyl and having a carbon number that is less than or equal to 8. Preferably, the first polyol is a diyol having a symmetrical structure and having a carbon number that is less than or equal to 4, and the second chain extender is a diyol having an ether group or a hydrocarbyl and having a carbon number that is less than or equal to 6. That is to say, the carbon number of the first chain extender and the carbon number of the second chain extender are relatively low, and other chain extenders having a carbon number greater than 8 is not suitable to be compared to the first chain extender and the second chain extender of the present embodiment.

In the chain extender component of the present embodiment, a ratio between a weight percentage of the first chain extender and a weight percentage of the second chain extender is within a range from 9:1 to 4:1. Preferably, the ratio between the weight percentage of the first chain extender and the weight percentage of the second chain extender is within a range from 7.5:1 to 5.5:1, but the present disclosure is not limited thereto. In the chain extender component of the present embodiment, a content of the first chain extender is 80 to 99 parts by weight, and a content of the second chain extender is 1 to 20 parts by weight.

The polyurethane hot melt adhesive has a hard segment and a soft segment, the hard segment is formed by the isocyanate component and the chain extender component, and the soft segment is formed by the polyol component. A hard segment ratio is defined by a weight percentage of the hard segment divided by a sum of the weight percentage of the hard segment and a weight percentage of the soft segment. That is to say, the hard segment ratio = the weight percentage of the hard segment/(the weight percentage of the hard segment + the weight percentage of the soft segment).

The hard segment ratio of the polyurethane hot melt adhesive is within a range from 25% to 45%. Preferably, the hard segment ratio of the polyurethane hot melt adhesive is within a range from 30% to 40%, but the present disclosure is not limited thereto. In other words, a soft segment ratio can be defined by the weight percentage of the soft segment divided by the sum of the weight percentage of the hard segment and the weight percentage of the soft segment, and the soft segment ratio of the polyurethane hot melt adhesive is within a range from 55% to 75%. Preferably, the soft segment ratio of the polyurethane hot melt adhesive is within a range from 60% to 70%.

It is worth mentioning that the first chain extender is primarily configured to endow the polyurethane hot melt adhesive with basic physical properties (e.g., strength and hardness), and the second chain extender is primarily configured to adjust a melting point and the crystallinity of the polyurethane hot melt adhesive. More specifically, since the polyurethane hot melt adhesive contains a small amount of the second chain extender (which has a relatively low molecular weight), and the second chain extender has the ether group or the hydrocarbyl, the second chain extender can effectively increase a speed of crystallization and reduce the difficulty of crystallization. In addition, since the hard segment can be formed from the second chain extender, the content of the second chain extender cannot be too high. If the content of the second chain extender is too high, the hard segment ratio will increase, thereby preventing the forming temperature of the polyurethane hot melt adhesive from being effectively reduced.

In addition, since the hard segment ratio of the polyurethane hot melt adhesive of the present disclosure is relatively low, and the soft segment ratio is relatively high, the polyurethane hot melt adhesive of the present disclosure has an excellent adhesive strength.

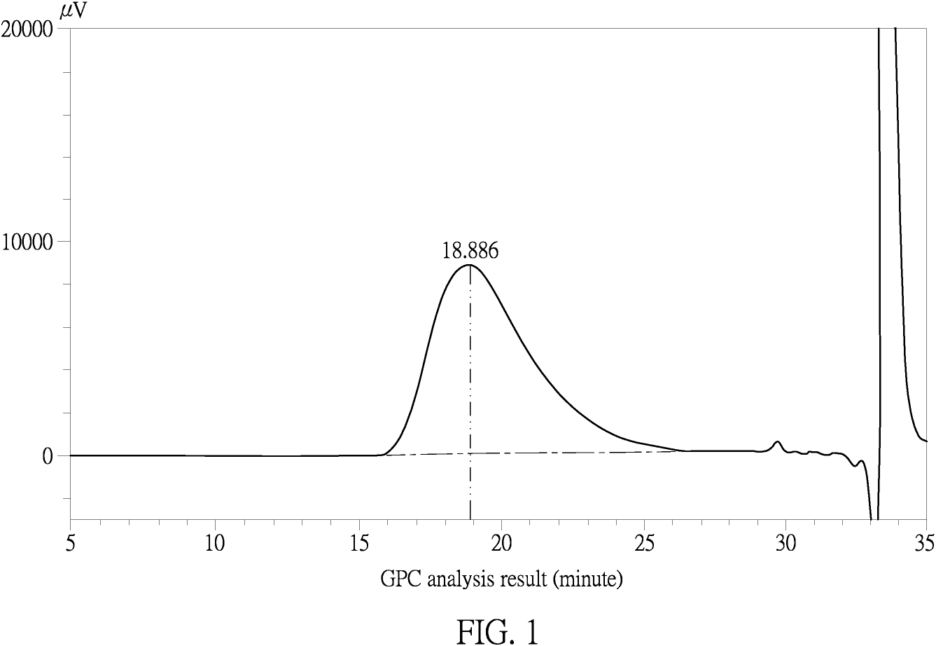

Referring to FIG. 1, FIG. 1 is a schematic view of an analysis result of a polyurethane hot melt adhesive by the gel permeation chromatography according to an embodiment of the present disclosure. The analysis result of the polyurethane hot melt adhesive by the gel permeation chromatography only includes one peak. In other words, a molecular weight distribution of the polyurethane hot melt adhesive in the present embodiment is relatively even. In addition, under 110° C. to 120° C., a rheological viscosity of the polyurethane hot melt adhesive is within a range from 2,000 Pa·s to 5,000 Pa·s. Preferably, the rheological viscosity of the polyurethane hot melt adhesive is within a range from 2,500 Pa·s to 4,500 Pa·s under the temperature condition of 110° C. to 120° C. Moreover, a change (i.e., a descent rate) between a viscosity of the polyurethane hot melt adhesive at 110° C. and a viscosity of the polyurethane hot melt adhesive at 120° C. is within a range from 30% to 33%. That is to say, the viscosity of the polyurethane hot melt adhesive at 120° C. is 67% to 70% of the viscosity of the polyurethane hot melt adhesive at 110° C. In other words, under a temperature condition of 100° C. to 140° C., the rheological viscosity of the polyurethane hot melt adhesive of the present disclosure is not easily changed.

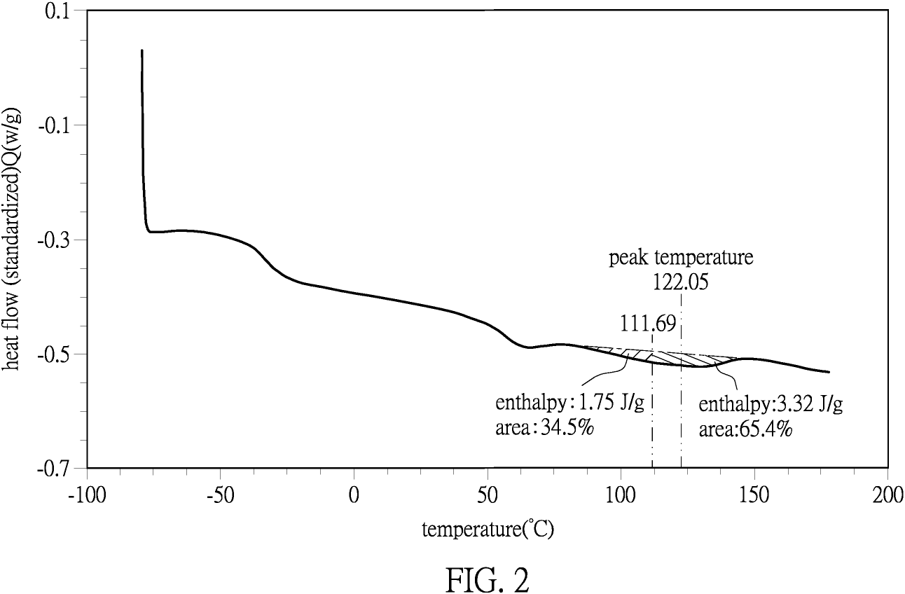

Referring to FIG. 2, FIG. 2 is a schematic view of an analysis result of the polyurethane hot melt adhesive by the differential scanning calorimetry according to the embodiment of the present disclosure. The analysis result of the polyurethane hot melt adhesive by the differential scanning calorimetry includes two peaks, the two peaks respectively correspond to a first melting point and a second melting point, the first melting point is within a range from 90° C. to 111.69° C., and the second melting point is within a range from 111.69° C. to 150° C., but the present disclosure is not limited thereto. An area encompassing the first melting point is 20% to 40% of a total area, and an area encompassing the second melting point is 60% to 80% of the total area. The total area is defined as an area surrounded by a DSC curve and a baseline in the analysis result, and the baseline is defined as a straight line connecting a lower limit of the first melting point (i.e., a coordinate on the DSC curve where a temperature is 90° C.) and an upper limit of the second melting point (i.e., a coordinate on the DSC curve where the temperature is 150° C.). Preferably, the area encompassing the first melting point is 30% to 35% of the total area, and the area encompassing the second melting point is 65% to 70% of the total area. In other words, in the analysis result by the differential scanning calorimetry, a ratio between the area encompassing the first melting point and the area encompassing the second melting point is within a range from 1:1.5 to 1:4.

In other embodiments, the polyurethane hot melt adhesive further includes a high heat resistant antioxidant, a UV absorbent, and a hydrolysis inhibitor, so as to enhance relevant properties of the polyurethane hot melt adhesive. However, the present disclosure is not limited thereto. Based on 100 parts by weight of polyurethane hot melt adhesive, a content of the high heat resistant antioxidant is 0.1 to 1 part by weight, a content of the UV absorbent is 0.1 to 0.8 parts by weight, and a content of the hydrolysis inhibitor is 0.2 to 2 parts by weight. Preferably, based on 100 parts by weight of the polyurethane hot melt adhesive, the content of the high heat resistant antioxidant is 0.3 to 0.8 parts by weight, the content of the UV absorbent is 0.3 to 0.6 parts by weight, and the content of the hydrolysis inhibitor is 0.6 to 1.6 parts by weight.

In the present embodiment, the high heat resistant antioxidant is at least one selected from the group consisting of tetrakis(β-(3,5-di-tert-butyl-4-hydroxyphenyl)propanoate)pentaerythritol, 3-(3,5-di-tert-butyl-4-hydroxybenzyl) mesitylene, and β-(4-hydroxyphenyl-3,5-di-tert-butyl)propionic acid n-octadecyl ester, the UV absorbent is at least one selected from the group consisting of bis(2,2,6,6-tetramethyl-4-pyridyl)sebacate, 2-(2H-benzotriazol-2-yl)-4,6-bis(1-methyl-1-phenylethyl)phenol, and 2-(2H-benzotriazol-2-yl)-6-dodecyl-4-methylphenol, and the hydrolysis inhibitor is at least one selected from the group consisting of bis(2,6-diisopropylphenyl)carbodiimide and bis(4-phenoxy-2,6-diisopropylphenyl)carbodiimide.

### Experimental Results

Hereinafter, a more detailed description will be provided with reference to Exemplary Examples 1 to 5 and Comparative Examples 1 to 3. However, the Exemplary Examples below are only used to aid in understanding of the present disclosure, and are not to be construed as limiting the scope of the present disclosure. In Exemplary Examples 1 to 3, their hard segment ratios are respectively adjusted to 32%, 30%, and 34%. The content of the first polyol in each of Exemplary Examples 4 and 5 is greater than the content of the first polyol in each of Exemplary Examples 1 to 3. The second polyol is not added in Comparative Example 1, the first polyol is not added in Comparative Example 2, and the second chain extender is not added in Comparative Example 3.

Components, forming conditions, adhesive properties, and changes of the rheological viscosity of the polyurethane hot melt adhesives in Exemplary Examples 1 to 5 and Comparative Examples 1 to 3 are listed in Table 1 below, and relevant testing methods are described as follows.

With respect to the forming conditions, two thermoplastic polyurethane adhesive tapes are taken as two substrates, and each of the thermoplastic polyurethane adhesive tapes is laminated and has a thickness within a range from 0.2 mm to 0.3 mm. The polyurethane hot melt adhesive is sandwiched between the two substrates, and is hot pressed for 20 seconds to 50 seconds under a temperature condition of 110° C. to 140° C. and a pressure condition of 10 kg/cm² to 50 kg/cm². The above-mentioned forming conditions can be correspondingly adjusted according to substrate types and the thickness of the hot melt adhesive.

An adhesive property test includes: testing a sample having a length of 10 cm and a width of 3 cm under a pulling speed of 200 MM/min.

A rheological viscosity change test includes: testing the viscosity at 110° C. and the viscosity at 120° C. with a dynamic mechanical analyzer and comparing the two viscosities, so as to obtain a viscosity descent rate.

TABLE 1

Components of Exemplary Examples and Comparative Examples and Test Results of Their Physical and Chemical Properties

| | | | | | | |
|---|---|---|---|---|---|---|
| Item | | Exemplary Example 1 | Exemplary Example 2 | Exemplary Example 3 | Exemplary Example 4 | Exemplary Example 5 |
| Parameter of each component | content of isocyanate component (parts by weight) | 28.3 | 27.0 | 29.7 | 29.9 | 30.6 |
| | content of polyol component (parts by weight) | 68.0 | 70.0 | 66.0 | 66.0 | 66.0 |
| | content of chain extender component (parts by weight) | 3.7 | 3.0 | 4.3 | 4.1 | 3.4 |
| | content of first polyol in polyol component (parts by weight) | 8.2 | 8.4 | 7.9 | 16.5 | 39.6 |
| | content of second polyol in polyol component (parts by weight) | 59.8 | 61.6 | 58.1 | 49.5 | 26.4 |
| | content of first chain [extender in chain extender component parts by weight) | 3.2 | 2.6 | 3.8 | 3.6 | 3.0 |
| | content of second chain extender in chain extender component (parts by weight) | 0.5 | 0.4 | 0.5 | 0.5 | 0.4 |
| | hard segment ratio of polyurethane hot melt adhesive (%) | 32 | 30 | 34 | 32 | 32 |
| Tet results | forming temperature (°C) of polyurethane hot melt adhesive (upper board/lower board) | 110/120 | 110/120 | 110/120 | 110/120 | 110/120 |
| | ratio between area encompassing first melting point and total area (%) | 35 | 34 | 30 | 29 | 32 |
| | adhesive property of polyurethane hot melt adhesive (kg/3 cm) | 9.2 | 7.9 | 8.4 | 8.7 | 9.0 |
| | change (%) of rheological viscosity of polyurethane hot | 30.7 | 32.1 | 31.8 | 30.9 | 32.8 |
| | melt adhesive between 110° C. and 120° C. | | | | | |

| Item | | Comparative Example 1 | Comparative Example 2 | Comparative Example 3 |
|---|---|---|---|---|
| Parameter of each component | content of isocyanate component (parts by weight) | 30.1 | 28.1 | 28.4 |
| | content of polyol component (parts by weight) | 68.0 | 68.0 | 68.0 |
| | content of chain extender component (parts by weight) | 1.9 | 3.9 | 3.6 |
| | content of first polyol in polyol component (parts by weight) | 68.0 | 0 | 8.0 |
| | content of second polyol in polyol component (parts by weight) | 0 | 68.0 | 59.8 |
| | content of first chain extender in chain extender component (parts by weight) | 1.6 | 3.4 | 3.6 |
| | content of second chain extender in chain extender component (parts by weight) | 0.3 | 0.5 | 0 |
| | hard segment ratio of | 32 | 32 | 32 |
| | polyurethane hot melt adhesive (%) | | | |
| Test results | forming temperature (°C) of polyurethane hot melt adhesive (upper board/lower board) | 110/120 | 110/120 | 110/120 |
| | ratio between area encompassing first melting point and total area (%) | 20 | 18 | - |
| | adhesive property of polyurethane hot melt adhesive (kg/3 cm) | 5.9 | 6.8 | 4.7 |
| | change (%) of rheological viscosity of polyurethane hot melt adhesive between 110° C. and 120° C. | 40.7 | 38.3 | 46.8 |

### Discussion of Test Results

In the polyurethane hot melt adhesives of Exemplary Examples 1 to 5, the first polyol and the second polyol that have different number-average molecular weights are used and a small amount of the second chain extender is added. Therefore, compared to Comparative Examples 1 to 3, the polyurethane hot melt adhesives of Exemplary Examples 1 to 5 can have better adhesive properties and relatively smaller changes of the rheological viscosity (i.e., decent rates), and are more suitable for application in shoe materials.

### Beneficial Effects of the Embodiment

In conclusion, in the polyurethane hot melt adhesive provided by the present disclosure, by virtue of “the second chain extender is a diyol having an ether group or a hydrocarbyl,” “a ratio between a weight percentage of the first chain extender and a weight percentage of the second chain extender is within a range from 9:1 to 4:1,” and “the hard segment ratio of the polyurethane hot melt adhesive is within a range from 25% to 45%,” the polyurethane hot melt adhesive can have a relatively low forming temperature.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyurethane hot melt adhesive, characterized in that the polyurethane hot melt adhesive is formed by reacting an isocyanate component, a polyol component, and a chain extender component;
wherein the polyol component includes a first polyol and a second polyol, a number-average molecular weight of the first polyol is within a range from 650 to 1,500, and a number-average molecular weight of the second polyol is within a range from 1,500 to 3,000;
wherein the chain extender component includes a first chain extender and a second chain extender, wherein the first chain extender is at least one selected from the group consisting of 1,4-butanediol and ethylene glycol, wherein the second chain extender is a diyol having an ether group or a hydrocarbyl and the second chain extender has a carbon number that is less than or equal to 8, and wherein a ratio between a weight percentage of the first chain extender and a weight percentage of the second chain extender is within a range from 9:1 to 4:1;
wherein the polyurethane hot melt adhesive has a hard segment and a soft segment, the hard segment is formed by the isocyanate component and the chain extender component, and the soft segment is formed by the polyol component, and wherein a hard segment ratio is defined by a weight percentage of the hard segment divided by a sum of the weight percentage of the hard segment and a weight percentage of the soft segment, and the hard segment ratio of the polyurethane hot melt adhesive is within a range from 25% to 45%;
wherein an analysis result of the polyurethane hot melt adhesive by a differential scanning calorimetry (DSC) includes two peaks, the two peaks respectively correspond to a first melting point and a second melting point, the first melting point is within a range from 90° C. to 111.69° C., and the second melting point is within a range from 111.69° C. to 150° C., and wherein an area encompassing the first melting point is 20% to 40% of a total area, the total area is defined as an area that is surrounded by a DSC curve and a baseline in the analysis result, and the baseline is defined as a straight line connecting a lower limit of the first melting point and an upper limit of the second melting point;
wherein a forming temperature of the polyurethane hot melt adhesive is within a range from 100° C. to 150° C.

2. The polyurethane hot melt adhesive according to claim 1, wherein the second chain extender is at least one selected from the group consisting of diethylene glycol, dipropylene glycol, and neopentyl glycol.

3. The polyurethane hot melt adhesive according to claim 1, wherein, based on 100 parts by weight of the polyurethane hot melt adhesive, a content of the isocyanate component is 27 to 30 parts by weight, a content of the polyol component is 66 to 70 parts by weight, and a content of the chain extender component is 3 to 4 parts by weight.

4. The polyurethane hot melt adhesive according to claim 1, wherein, under a temperature condition of 110° C. to 120° C., a rheological viscosity of the polyurethane hot melt adhesive is within a range from 2,000 Pa·s to 5,000 Pa·s.

5. The polyurethane hot melt adhesive according to claim 1, wherein a ratio between a weight percentage of the first polyol and a weight percentage of the second polyol is within a range from 9:1 to 1.5:1.

6. The polyurethane hot melt adhesive according to claim 1, wherein the first polyol is at least one selected from the group consisting of adipic acid-butanediol, adipic acid-butanediol-ethylene glycol, and adipic acid-succinic acid-hexanediol, and the second polyol is at least one selected from the group consisting of adipic acid-butanediol, adipic acid-butanediol-ethylene glycol, and adipic acid-succinic acid-hexanediol.

7. The polyurethane hot melt adhesive according to claim 1, wherein the forming temperature of the polyurethane hot melt adhesive is within a range from 110° C. to 130° C.

8. The polyurethane hot melt adhesive according to claim 1, wherein an analysis result of the polyurethane hot melt adhesive by a gel permeation chromatography (GPC) only includes one peak.

9. The polyurethane hot melt adhesive according to claim 1, further comprising a high heat resistant antioxidant, a UV absorbent, and a hydrolysis inhibitor, wherein, based on 100 parts by weight of the polyurethane hot melt adhesive, a content of the high heat resistant antioxidant is 0.1 to 1 parts by weight, a content of the UV absorbent is 0.1 to 0.8 parts by weight, and a content of the hydrolysis inhibitor is 0.2 to 2 parts by weight.

10. The polyurethane hot melt adhesive according to claim 9, wherein the high heat resistant antioxidant is at least one selected from the group consisting of tetrakis(β-(3,5-di-tert-butyl-4-hydroxyphenyl)propanoate)pentaerythritol, 3-(3,5-di-tert-butyl-4-hydroxybenzyl)mesitylene, and β-(4-hydroxyphenyl-3,5-di-tert-butyl)propionic acid n-octadecyl ester, wherein the UV absorbent is at least one selected from the group consisting of bis(2,2,6,6-tetramethyl-4-pyridyl)sebacate, 2-(2H-benzotriazol-2-yl)-4,6-bis(1-methyl-1-phenylethyl)phenol, and 2-(2H-benzotriazol-2-yl)-6-dodecyl-4-methylphenol, and wherein the hydrolysis inhibitor is at least one selected from the group consisting of bis(2,6-diisopropylphenyl)carbodiimide and bis(4-phenoxy-2,6-diisopropylphenyl)carbodiimide.
